(19) United States
(12) Patent Application Publication
(10) Pub. No.: US 2023/0038903 A1
(43) Pub. Date: Feb. 9, 2023

(54) HUMAN-MACHINE INTERFACE DEVICE FOR BUILDING SYSTEMS

(71) Applicant: INVENTIO AG, Hergiswil (CH)

(72) Inventor: Markus Kappeler, Winterthur (CH)

(21) Appl. No.: 17/787,489

(22) PCT Filed: Dec. 14, 2020
(86) PCT No.: PCT/EP2020/085997

§ 371 Date: Jun. 20, 2022

(30) Foreign Application Priority Data
Dec. 16, 2019 (EP) 19216497.8

(51) Int. Cl. G05B 19/042

(52) U.S. Cl. CPC G05B 19/042; G05B 2219/25011

(57) ABSTRACT

A human-machine interface device can be arranged on a building. The device can include a communication device, a recording device, an optical projection module and a control device. The communication device sends and receives data signals via a communication network, and the recording device records data relating to a user. The control device is configured to transmit user data recorded by the recording device to a control system of a building system and to control the optical projection module based on routing information. The optical projection module is configured to project routing information relating to the user and visible to the user onto a projection surface.

### TECHNICAL FIELD

The technology described herein relates generally to a building system that performs one or more services in or for a building. Embodiments of the technology relate in particular to a human-machine interface device and to a building system having such a human-machine interface device.

### SUMMARY

Building systems can be configured in various ways for a wide variety of applications. In a building, for example, it may be desirable to detect the presence of a user in the building. This desire may lie with the user, who wishes to orient himself in the building, for example after entering the building. The desire may also exist on the part of the building management, which would like to know, for example, whether and when a user is in the building and which service the user would like to use in the building.

The presence of a user can be detected, for example, with an access control system, which is an example of a building system. The access control system controls, for example, access to a restricted-access zone (for example, a building entrance or floor corridors with access to elevators). In such an access control system, users who want to use the service of the access control system can identify themselves to a human-machine interface device as authorized in different ways, i.e. with different credentials, for example with user-individual biometric features, a key, a magnetic card, chip card, or RFID card, or a mobile electronic device (e.g. a mobile phone). WO 2010/112586 A1 describes an access control system in which a mobile phone carried by a user transmits an identification code to an access node. If the identification code is identified as valid, the access node transmits an access code to the mobile phone, which displays the access code on a display. If the user holds the displayed access code up to a camera, the access control system checks whether the recorded access code is valid. If the code is valid, the user is granted access.

Another example of a building system is an elevator system installed in the building. In order to use the service of the elevator system, a user can, for example, input an elevator call at a human-machine interface device, also referred to as an elevator operating device or floor call terminal, in order to be transported from a boarding floor to a destination floor. Depending on the type and purpose of a building, the elevator system and the access control system can be configured in such a way that an elevator call is initiated when the user is granted access; the elevator call can be made, for example, to a specified destination floor that is stored in a user profile created for the user.

The human-machine interface devices of these building systems allow a user to interact with the building system at least at the beginning of the service request. For example, if the user presents valid credentials, the building system reacts to this, e.g. by granting access and/or displaying an elevator assigned to the elevator call on a screen of the elevator operating device. In buildings with a high volume of traffic, for example in office buildings during morning rush hours, not only should access and call assignment be as quick as possible, but users should also move away from the human-machine interface devices as quickly as possible in order to reduce the risk of queues forming. There is therefore a need for a technology for a building system that ensures in particular that users can move away from the human-machine interface devices as quickly as possible, but without sacrificing comfort or information transfer.

One aspect of such technology relates to a human-machine interface device having a housing configured to be arranged on a floor or wall of a building. A communication device and a recording device are arranged in the housing. The communication device is configured to transmit and receive data signals via a communication network, and the recording device is configured to record data relating to a user. An optical projection module is also arranged in the housing, which module is configured to project routing information relating to the user and visible to the user onto the floor or onto a projection surface on the wall. A control device which is also arranged in the housing is communicatively connected to the recording device, the communication device and the optical projection module. The control device is configured to transmit user data recorded by the recording device to a control system of a building system by means of the communication device and to control the optical projection module by means of routing information received from the control system.

Another aspect of the technology relates to a building system having such a human-machine interface device. Properties of this human-machine interface device and the advantageous configurations thereof are specified below.

The technology described herein provides a human-machine interface device that can be used for different applications in the building system of a building; in principle, it can be used wherever building- and/or service-specific information is to be communicated to a user. In one embodiment, the information is conveyed in connection with a building access control system and/or an elevator system. A control system of the building system can perform a building access control function and/or an elevator control function for this purpose.

In one of these applications in the building system, the human-machine interface device can be integrated into a gate of the building access control system. In this application, the optical projection module projects the routing information onto the floor. In one embodiment, the routing information is projected exclusively onto the floor, so that there is no need for a display device in the gate.

In a further application in the building system, the human-machine interface device can be integrated into an elevator operating device of an elevator system. In this application, the optical projection module projects the routing information either onto the projection surface on the building wall or onto the floor. There is also no need for a display device in the elevator operating device in this embodiment; the elevator operating device can therefore have a size that is reduced by at least the size of the display device, as a result of which it can also be more cost-effective.

In one embodiment of the human-machine interface device, the optical projection module comprises a laser device that emits visible light. Such a laser device allows high-quality light projection (e.g. with regard to edge sharpness) in a relatively simple manner

In addition, the optical projection module offers a high degree of flexibility with regard to the display of the routing information. The optical projection module can project the routing information, for example, as individual letters, text, symbols and/or pictograms. Depending on the configuration, the size of the routing information displayed can also be adapted to the location and the use of the human-machine interface device.

In one embodiment, the optical projection module may statically project the routing information for a fixed period of time. The period of time can be adjusted based on location and use.

Alternatively, in one embodiment, the optical projection module may dynamically project the routing information for a fixed period of time. The dynamic projection can take place, for example, in pulses (repeated light on/light off), pulsating (brightness increases and decreases again, repeatedly) and/or as a running light. This increases perception by a user.

In one embodiment, the recording device of the human-machine interface device is configured to record a user's credentials. The recording device can be configured in various ways. The recording device may comprise a keypad to allow the user to enter a PIN code. The keypad can comprise electromechanical keys or can be displayed on a touch-sensitive screen arranged in the human-machine interface device.

The recording device can additionally or alternatively comprise an optical camera system which is configured to record a fingerprint of the user, an iris pattern of the user, a face of the user, an optical code and/or a photo ID of the user. In one embodiment, the recording device can comprise a magnetic card reader, a chip card reader and/or an RFID card reader in order to record the credentials. In one embodiment, the recording device can comprise a radio receiving device in order to receive a radio signal emitted by a mobile device carried by the user. A person skilled in the art recognizes that depending on the building, depending on the credentials specified for a building, or depending on the credentials preferred by the users, the recording device may comprise one or more of the devices mentioned.

### BRIEF DESCRIPTION OF THE DRAWINGS

Various aspects of the improved technology are described in greater detail below with reference to embodiments in conjunction with the drawings. In the drawings, identical elements have identical reference signs. In the drawings:

FIG. 1 is a schematic representation of an application example of a building system having a human-machine interface device in connection with an example of a situation in a building;

FIG. 2 is a schematic representation of a first embodiment of a human-machine interface device; and

FIG. 3 is a schematic representation of a second embodiment of a human-machine interface device.

### DETAILED DESCRIPTION

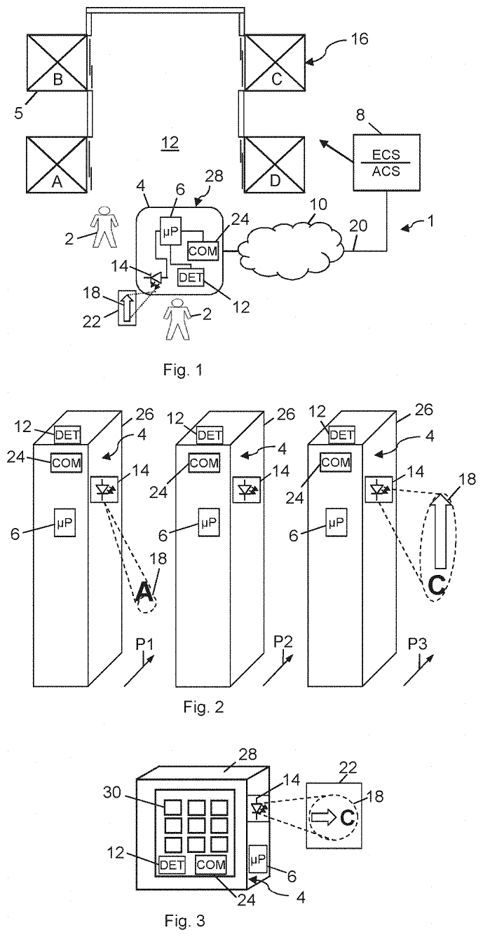

FIG. 1 is a schematic representation of an application example of a building system 1 in connection with an example of a situation in a building; for purposes of illustration, only a few walls, rooms 5 and a building zone 12 are shown. The rooms 5 may be, for example, offices, apartments, halls and/or elevator cars of an elevator system 16. In one embodiment, the building zone 12 may comprise a public zone from which restricted-access zones, such as the rooms 5 or an elevator car of the elevator system 16, can be entered. In this embodiment, the building system 1 can be a split-off system or subsystem of an access control system that monitors access to the building zone 12 and/or of the elevator system 16. In another embodiment, the building system 1 can be a system that is independent of another system, in particular an access control system or an elevator system. In the application of the building system 1 shown in FIG. 1, there are several users 2 in the building zone 12.

FIG. 1 also shows a human-machine interface device 4, which comprises a recording device 12 (DET in FIG. 1), a communication device 24 (COM in FIG. 1), a control device 6 (μP in FIG. 1) and an optical projection module 14. A person skilled in the art recognizes that the human-machine interface device 4 can comprise a speaker system in order to announce routing information e.g. by means of a voice message; this can be helpful in particular for users 2 with limited vision. These components of the human-machine interface device 4 are arranged in a housing 28. Depending on the application, the housing 28 can comprise a housing of a gate 26 shown in FIG. 2 or of an elevator operating device shown in FIG. 3. The human-machine interface device 4 is communicatively connected to a communication network 10 which is also communicatively connected to a control system 8 of the building system 1.

The projection module 14 is configured to project routing information 18 relating to the user 2 and visible to the user 2 onto the floor or onto a projection surface 22 on a wall of the building; in FIG. 1, the routing information 18 is shown by way of example as an arrow. The arrow shows the direction that leads to the desired destination. In another embodiment, elevator information or building information can be projected as routing information 18 as an alternative or in addition to the direction.

Depending on the application, the projection module 14 can be configured to project, as routing information 18, individual letters, text, symbols (e.g. arrows, dots, circles, etc.) or pictograms (e.g. for an elevator, a door, escape route, etc.) alone or in combination (as indicated, for example, in FIG. 2). For this purpose, the projection module 14 can have programmable control software and/or be controlled accordingly by the control device 6. The optical projection module 14 may be configured to statically project the routing information 18 for a fixed period of time; the period of time can be determined, for example, for a building and for a location in the building by testing. The optical projection module 14 may also be configured to dynamically project the routing information 18 for a specified period of time, for example in pulses (repeated light on/light off), pulsating (brightness increases and decreases alternately) and/or as a running light. In one embodiment, the projection module 14 comprises a laser scanner, which projects the routing information 18 onto the floor or the projection surface 18 by means of laser radiation. Such laser scanners are commercially available, e.g. as a microscanner from Bosch Sensortec GmbH, Germany.

The recording device 12 is configured to record data relating to a user 2. This user data can be entered by the user 2 or read from credentials of the user 2 and thus recorded. Design examples of the recording device 12 are specified elsewhere in this description.

In the example of a situation shown in FIG. 1, the technology described herein can be used in an advantageous manner Summarized briefly and by way of example, the technology described herein provides a building system 1 in which the projection module 14 of a human-machine interface device 4 projects the routing information 18 intended for a user 2 onto the floor or a projection surface 22. The control device 6 of the human-machine interface device 4 can transmit the user data, which the recording device 12 records, to a control system 8 of the building system 1 by means of the communication device 24. Based on the received user data, the control system 8 determines the routing information 18 for the user 2 and transmits this to the control device 6. The control device 6 controls the projection module 14 accordingly in order to project the routing information 18 onto the floor or the projection surface 22. There is therefore no need for a display device, e.g. in the form of a screen or a touch-sensitive screen, in the human-machine interface device 4.

The routing information 18 projected in this way can be seen and perceived by the user 2 over a relatively large viewing angle and over a relatively large distance, i.e. even if the user 2 moves, e.g. if he is already moving away from the human-machine interface device 4, the routing information 18 can still be perceived. The user 2 is therefore not reliant on reading, perceiving and remembering the routing information 18 directly on the human-machine interface device 4. Application examples of the human-machine interface device 4 are described in connection with FIGS. 2 and 3.

In one embodiment, the human-machine interface device 4 is a subsystem of the building system 1 that is controlled by a control system 8. The building system 1 can comprise an elevator system 16 and/or an access control system. A person skilled in the art recognizes that a large number of human-machine interface devices 4 for elevator operation and/or for access control can be arranged in the building. A person skilled in the art also recognizes that the human-machine interface device 4 can also be used in another building system, e.g. in a building information system, for example for visitors. Such a building information system can be independent of an access control system or the elevator system 16.

When used in the elevator system 16, the human-machine interface device 4 (also referred to as elevator operating device, call input device or floor terminal) is arranged, for example, in the access region to the elevators (A, B, C, D) on a building wall or standing on the floor. When used in an access control system, the human-machine interface device 4 is arranged, for example, in or on a gate 26 (as shown in FIG. 2) which separates a public area of the building zone 12 from a restricted-access area of the building zone 12.

Depending on the application, the control system 8 comprises an elevator control device (shown as ECS in FIG. 1) and/or a control device (shown as ACS in FIG. 1) of the access control system. A person skilled in the art recognizes that the control system 8 for the access control system 1 and the elevator control device may be separate systems, including spatially separate systems, and accordingly may be represented as separate systems.

As mentioned above, the recording device 12 is configured to record data relating to a user 2. The data can include, for example, a building service request or a code (ID code) or access code assigned to the user 2. In one embodiment, the data may be recorded based on credentials. The credentials can, for example, be in the form of a physical key, a manually input password (e.g. a PIN code), a biometric feature (e.g. fingerprint, iris pattern, facial characteristics, speech/voice characteristics), an optical code (QR code or color code) or data recorded from a magnetic card, chip card or RFID card or from an electronic device (NFC-, Bluetooth- or cellular network-based). The recording device 12 is configured for the credentials provided for the user 2 or in the building: A keypad (electromechanical or displayed on a touch-sensitive screen (touchscreen)) can be provided for recording a PIN code; an optical camera system can be provided for recording a fingerprint, iris pattern, face, an optical code or a photo ID (e.g. a machine-readable passport); and corresponding electronic readers can be provided for recording data from magnetic, chip or RFID cards or an electronic device.

In one embodiment, the recording device 12 detects a data signal emitted as a radio signal by a mobile device carried by the user 2. The radio signal can be transmitted in accordance with a known standard for radio communication (e.g., RFID, WLAN/WiFi, NFC, Bluetooth). Correspondingly, the recording device 12 is configured to receive such a radio signal; a person skilled in the art recognizes that a known transceiver and associated antenna can be used for this purpose.

In one embodiment, the data recorded by the recording device 12 are transmitted to the control system 8 for further processing. If the data relate to credentials, the control system 8 checks whether the user 8 is authorized to use the service. If the credentials are valid, the user 2 can be granted access, for example, or an elevator call can be registered for the user 2. If the data concern a building service request that does not require credentials, the control system 8 processes this without authentication. The control system 8 then determines the relevant routing information 18 and transmits this to the human-machine interface device 4.

For the authorization check, the control system 8 accesses a database system in which a data set, also referred to as a user profile, is stored for each registered user 2, 2a. The user profile can include, for example, personal data of the user 2 (e.g.

name, reason for authorization (resident, employee, external service provider, visitor)), telephone number(s), email address(s), access authorizations (e.g. certain rooms 5 and floors) and any time restrictions (e.g. access from Monday to Friday, from 7:00 a.m. to 8:00 p.m.). If the authorization check is carried out in connection with the elevator system 16, the user profile can also include a default value for the destination floor (default floor).

FIG. 2 is a schematic representation of a first embodiment of the human-machine interface device 4 in an application in an example of a gate 26. In FIG. 2, three gates 26 are arranged side by side and form three passageways P1, P2, P3, indicated by arrows pointing from the public zone toward the restricted-access zone. If the user 2 wants to get into the restricted-access zone, he moves through one of the passages P1, P2, P3 in the direction indicated by the relevant arrow. A person skilled in the art recognizes that, for example, turnstiles, barriers, doors or other physical barriers can be arranged in the passages P1, P2, P3. A person skilled in the art also recognizes that in another embodiment, fewer or more than three gates 26 can be arranged.

In the embodiment shown in FIG. 2, each gate 26 comprises a human-machine interface device 4. The communication device 24 of the human-machine interface device 4 in the particular gate 26 is connected to the control system 8 via the communication network 10. For the purposes of illustration, the projection module 14 of the gate 26 forming the passage P1 displays an elevator identifier (A) as routing information 18, and the projection module 14 of the gate 26 forming the passage P3 displays an elevator identifier (C) as routing information 18 and a direction indicator (arrow).

The gates 26 shown in FIG. 2 can be arranged in a building in which both an access control system and an elevator system 16 are installed. In such a building, access control and inputting an elevator call can be carried out substantially simultaneously. For example, if the user 2 approaches the gate 26 for the passage P1 so that his credentials can be recorded there, the access control system grants him access to the passage P1 if the access authorization is valid and the elevator system 16 allocates him an elevator based on his user profile which transports him to the desired destination floor. The projection module 14 projects the routing information 18, i.e. the elevator identifier (A), onto the floor in passage P1 or (in the direction of the arrow) shortly after the passage P1, possibly already in the restricted-access zone. The routing information 18 is thus projected in front of the user 2 in the direction of travel. Because a relatively small display at the gate 26 can be overlooked, for example, in particular by users 2 walking quickly, the technology described herein with the projection in front of the user 2 improves comfort and the flow of people at the gate 26.

FIG. 3 is a schematic representation of a second embodiment of a human-machine interface device 4 in an application in an example of an elevator operating device. Depending on the building and the elevator system 16 installed in the building, the elevator operating device has one or more call buttons 30 in order to allow a user 2 to input an elevator call. In one embodiment, the recording device 12 comprises the call buttons 30. Alternative configurations of the elevator operating device, in particular with regard to the call input, are specified elsewhere in this description; for example, an optical code reading unit or an RFID reader can be provided.

The housing 28 of the human-machine interface device 4 comprises the housing of the elevator operating device, which can be arranged on a building wall by means of surface-mounted or flush-mounted installation. Depending on the installation, the housing 28 is more or less arranged in the building wall, so that under certain circumstances only a front side of the housing facing the user 2 is visible; if a flush-mounted installation is provided, a large part of the housing 28 can be omitted. A person skilled in the art recognizes that the remaining part, possibly only the front, also forms the housing, while the components are arranged on one or more printed circuit boards. A person skilled in the art also recognizes that the housing 28 or the elevator operating device can be arranged at a distance from the building wall, for example by means of a support frame fastened to the wall, or free-standing on the floor by means of a pedestal.

In one embodiment, the projection surface 22 is on the building wall; the location of the projection surface 22 is defined in such a way that it can be seen and perceived by the user 2 while he is still at the elevator operating device. The projection surface 22 can be fixed, for example, above, including laterally offset, laterally (as shown in FIG. 3) or laterally offset below the elevator operating device. If the elevator operating device is separated from the wall, the projection surface 22 can also be located behind or diagonally behind the elevator operating device. Depending on the arrangement of the elevator operating device, the projection surface 22 can also be located on the floor. The human-machine interface device 4 of the elevator operating device is configured in such a way that the optical projection module 14 projects the routing information 18 onto the defined projection surface 22.

A person skilled in the art recognizes that the human-machine interface device 4 can, alternatively or additionally, be used in connection with an access control system and/or an elevator system in general for guiding people, in particular people who have little or no familiarity with the building, e.g. visitors. Such guidance can be particularly helpful in complex buildings. In such a building, the human-machine interface device 4 can be installed at critical points, e.g. at intersecting and/or branching corridors. In such an application, the human-machine interface device 4 can be equipped with a camera system that takes a picture of a user 2. If the user 2 moves toward the human-machine interface device 4, for example, the captured image can then be evaluated by an algorithm for face recognition. If the user 2 is recognized, the optical projection module 14 projects the routing information 18 onto the floor. Following this routing information, the user 1 can find his way around the building more easily.

In one embodiment, the control system 8 can be arranged in the building. In another embodiment, the control system 8 can be arranged entirely or in part in an off-site control center, or implemented as an IT infrastructure made available via the Internet (also referred to as “cloud computing”). The communicative connection between the control system 8 and the communication network 10 is indicated by a communication connection 20.

The communication network 10 can comprise a building-internal communication network to which the or each human-machine interface device 4 is connected within the building. The building-internal communication network can comprise a wired network topology (e.g. a bus, ring, mesh topology) and/or a radio-based network topology (WLAN). In a further embodiment, the control system 8 can be located entirely or in part at a site which is remote from the building. In this case, the control system 8 can be connected to the building-internal communication network via an external communication network. For this purpose, an interface device is present in the building-internal communication network, which device allows communication between the building-internal communication network and the external communication network.

1. A human-machine interface device, comprising:
a housing configured to be arranged on a floor or wall of a building;
a communication device on or within the housing, the communication device configured to transmit and receive data signals via a communication network;
a recording device on or within the housing, the recording device configured to record data relating to a user;
an optical projection module on or within the housing, which isthe optical projection module configured to project routing information relating to the user and visible to the user onto the floor or onto a projection surface on the wall; and
a control device on or within the housing, the control device communicatively connected to the recording device, the communication device, and the optical projection module, wherein the control device is configured to:
transmit user data recorded by the recording device to a control system of a building system using the communication device, and
control the optical projection module based on routing information received from the control system.

2-15. (canceled)

16. The human-machine interface device of claim 1, wherein the optical projection module comprises a laser device which emits visible light.

17. The human-machine interface device of claim 1, wherein the optical projection module is configured to project individual letters, text, symbols and/or pictograms as routing information.

18. The human-machine interface device of claim 1, wherein the optical projection module is configured to statically project the routing information for a fixed period of time.

19. The human-machine interface device of claim 1, wherein the optical projection module is configured to dynamically project the routing information for a fixed period of time.

20. The human-machine interface device of claim 1, wherein the recording device is configured to record credentials of the user.

21. The human-machine interface device of claim 20, wherein the recording device comprises a keypad to allow the user to enter a PIN code.

22. The human-machine interface device of claim 20, wherein the recording device comprises a keypad to allow the user to enter a PIN code, wherein the keypad comprises electromechanical keys or can be displayed on a touch-sensitive screen arranged in the human-machine interface device.

23. The human-machine interface device of claim 20, wherein the recording device comprises an optical camera system which is configured to record a fingerprint of the user, an iris pattern of the user, a face of the user, an optical code, and/or a photo ID of the user.

24. The human-machine interface device of claim 20, wherein the recording device comprises a magnetic card reader, a chip card reader, and/or an RFID card reader in order to record the credentials.

25. The human-machine interface device of claim 20, wherein the recording device comprises a radio receiving device in order to receive a radio signal emitted by a mobile device carried by the user.

26. A building system comprising the human-machine interface device of claim 1.

27. The building system of claim 26, further comprising a control system which is configured to carry out a building access control function and/or an elevator control function.

28. The building system of claim 27, wherein the human-machine interface device is integrated into a gate of a building access control system, wherein the optical projection module projects the routing information onto the floor.

29. The building system of claim 27, wherein the human-machine interface device is integrated into an elevator operating device of an elevator system.

30. The building system of claim 27, wherein the recording device is configured to record credentials of the user.

31. The building system of claim 30, wherein the recording device comprises a keypad to allow the user to enter a PIN code.

32. The building system of claim 30, wherein the recording device comprises a keypad to allow the user to enter a PIN code, wherein the keypad comprises electromechanical keys or can be displayed on a touch-sensitive screen arranged in the human-machine interface device.

33. The building system of claim 30, wherein the recording device comprises an optical camera system which is configured to record a fingerprint of the user, an iris pattern of the user, a face of the user, an optical code, and/or a photo ID of the user.

34. The building system of claim 30, wherein the recording device comprises a magnetic card reader, a chip card reader, and/or an RFID card reader in order to record the credentials.
